(19) United States
(12) Patent Application Publication
(10) Pub. No.: US 2025/0035833 A1
(43) Pub. Date: Jan. 30, 2025

(54) OPTICAL LAMINATE, OPTICAL DEVICE, AND METHOD FOR PRODUCING OPTICAL LAMINATE

(71) Applicant: NITTO DENKO CORPORATION, Osaka (JP)

(72) Inventors: Tatsuya SUZUKI, Osaka (JP); Kaori MIZOBATA, Osaka (JP); Kaori SHINYA, Osaka (JP); Satoshi HONDA, Osaka (JP); Akiko TANAKA, Osaka (JP); Mizuho MIZUNO, Osaka (JP); Shigeki ISHIGURO, Osaka (JP)

(73) Assignee: NITTO DENKO CORPORATION, Osaka (JP)

(21) Appl. No.: 18/705,050

(22) PCT Filed: Oct. 21, 2022
(86) PCT No.: PCT/JP2022/039303

§ 371 Date: Apr. 26, 2024

(30) Foreign Application Priority Data
Oct. 29, 2021 (JP) 2021-178158

(51) Int. Cl. F21V 8/00

(52) U.S. Cl. CPC G02B 6/005

(57) ABSTRACT

An optical laminate includes: a first optical sheet that has a first main surface with a relief structure thereon and a second main surface on the reverse side from the first main surface; and a second optical sheet that has a third main surface disposed on the first main surface side of the first optical sheet. The relief structure of the first main surface includes a plurality of recessed portions and flat portions that are each between two recessed portions adjacent to one another among the plurality of recessed portions. The third main surface and the flat portions of the first main surface are bonded by covalent bonding with a molecular adhesive therebetween.

### TECHNICAL FILED

The present invention relates to an optical stack and an optical device having such an optical stack.

### BACKGROUND ART

Optical sheets (e.g., microlens sheets, prism sheets, brightness enhancement films (e.g., Brightness Enhancement Film: BEF (R) manufactured by 3M)) are used in various optical devices (e.g., display devices and illumination devices). In the present specification, “optical sheet” is not limited to those illustrated above, but broadly includes sheet-shaped optical components, and further includes, for example, diffusion plates and light guide plates. “Sheet-shaped” is meant to encompass a plate shape or a film shape, regardless of the stiffness (flexibility) and thickness of the sheet. An optical sheet is attached to another optical sheet or an optical device by using an adhesive layer, for example. In the present specification, “optical stack” refers to a configuration including an optical sheet and an adhesive layer or including a plurality of optical sheets. In the present specification, “adhesive” is meant to encompass tackiness agents (also referred to as “pressure-sensitive adhesives”).

The applicant has disclosed an optical stack (referred to as “optical sheet” in Patent Document 1) that can be used for display devices and illumination devices in Patent Document 1. The optical stack in Patent Document 1 has an optical sheet (e.g., microlens sheet) with a concavo-convex structure on its surface and an adhesive layer provided on the surface with the concavo-convex structure. The adhesive layer fills 5% to 90% of the convex height of the concavo-convex structure. The adhesive layer is formed from an adhesive composition containing a graft polymer, which is a (meth)acrylic polymer graft-polymerized with chains containing monomers containing cyclic ether groups, and a cationic photopolymerization initiator or heat-curing catalyst.

Moreover, Patent Documents 2 and 3 disclose light distribution structures that may be used for display devices or illumination devices, in which total reflection at interfaces of multiple air cavities (internal space) is utilized. With the light distribution structures disclosed in Patent Documents 2 and 3, freedom and accuracy of light distribution control can be improved. The entire disclosure of Patent Documents 2 and 3 is incorporated herein by reference.

### CITATION LIST

### Patent Literature

Patent Document No. 1: Japanese Laid-Open Patent Publication No. 2012-007046
Patent Document No. 2: International Publication No. 2011/124765
Patent Document No. 3: International Publication No. 2019/087118

### SUMMARY OF INVENTION

### Technical Problem

The inventors have considered forming the light distribution structures described in Patent Documents 2 and 3 by using a surface with a concavo-convex structure of an optical sheet with a concavo-convex structure on its surface and by disposing an adhesive layer on the surface with a concavo-convex structure. At this time, the shape and volume of the multiple air cavities that constitute the light distribution structures vary depending on the degree to which the adhesive layer penetrates into the dents of the concavo-convex structure, which consequently affects the characteristics of the light distribution structures. Therefore, it is desired to suppress the penetration of the adhesive layer into the dents of the concavo-convex structure.

Here, using the light distribution structures described in Patent Documents 2 and 3 as examples, a problem of optical stacks formed by stacking on a surface with a concavo-convex structure of an optical sheet another optical sheet using a conventional adhesive has been described, but this problem is not limited to the light distribution structures described in Patent Documents 2 and 3 and is common to optical stacks formed by stacking on a surface with a concavo-convex structure another optical sheet.

The present invention has been made in order to solve the aforementioned problem, and an objective thereof is to provide an optical stack in which an optical sheet and another optical sheet are stacked without substantially affecting the shape and volume of dents on a surface with a concavo-convex structure of the optical sheet, as well as an optical device having such an optical stack, and/or to provide a method for producing such an optical stack.

### Solution to Problem

According to embodiments of the present invention, means for solution as recited in the following Items are provided.

### Item 1

An optical stack comprising:
a first optical sheet having a first main surface with a concavo-convex structure and a second main surface on an opposite side from the first main surface; and
a second optical sheet having a third main surface that is disposed on a side of the first main surface of the first optical sheet, wherein,
the concavo-convex structure of the first main surface includes a plurality of dents and flat portions between two dents that are adjacent to each other of the plurality of dents, and
the flat portions of the first main surface and the third main surface are bonded by covalent bonding via a molecular adhesive.

### Item 2

The optical stack of Item 1, wherein for each of the plurality of dents, when a distance from an opening face defined by an opening of the dent to a deepest portion of the dent is defined as A and a point at which a distance from the opening face to the third main surface of the second optical sheet that has penetrated into the dent takes a maximum value B is defined as a point of maximum penetration, B/A is 0.2 or less.

### Item 3

The optical stack of Item 2, wherein the point of maximum penetration is positioned on a side of the deepest portion compared to a side surface of the dent.

### Item 4

The optical stack of any of Items 1 to 3, wherein a distance between the flat portions and the third main surface does not exceed 500 nm.

### Item 5

An optical stack comprising:
a first optical sheet having a first main surface with a concavo-convex structure and a second main surface on an opposite side from the first main surface; and
a second optical sheet having a third main surface that is disposed on a side of the first main surface of the first optical sheet, wherein,
the concavo-convex structure of the first main surface includes a plurality of dents and flat portions between two dents that are adjacent to each other of the plurality of dents,
for each of the plurality of dents, when a distance from an opening face defined by an opening of the dent to a deepest portion of the dent is defined as A and a point at which a distance from the opening face to the third main surface of the second optical sheet that has penetrated into the dent takes a maximum value B is defined as a point of maximum penetration, B/A is 0.2 or less, and
a distance between the flat portions and the third main surface does not exceed 500 nm.

### Item 6

The optical stack of Item 5, wherein the flat portions of the first main surface and the third main surface are bonded by covalent bonding via a molecular adhesive.

### Item 7

The optical stack of any of Items 1 to 4 and 6, wherein the molecular adhesive has at least one reactive group selected from the group consisting of an azide group, an amino group, a mercapto group, an isocyanate group, a ureido group, an epoxy group, a silanol group, and an alkoxysilyl group.

### Item 8

The optical stack of any of Items 1 to 4 and 6, wherein the molecular adhesive has an azide group, and a silanol group or an alkoxysilyl group.

### Item 9

The optical stack of Item 8, wherein the molecular adhesive further has a triazine ring, and the azide group is bonded to the triazine ring.

### Item 10

The optical stack of Item 9, wherein the flat portions and the third main surface have at least one reactive group selected from the group consisting of a hydrocarbon group, a carbonyl group, and a hydroxyl group, and form covalent bonding with the molecular adhesive.

### Item 11

The optical stack of any of Items 1 to 10, wherein the first optical sheet is formed of a cured material of a curable resin.

### Item 12

The optical stack of any of Items 1 to 11, having a haze value of 5.0% or less.

### Item 13

An optical device comprising a light guide plate having the optical stack of any of Items 1 to 12.

### Item 14

A method for producing the optical stack of any of Items 1 to 12, the method comprising:
step A of applying a molecular adhesive represented by the following general formula [I] to at least one of the flat portions of the first optical sheet and the third main surface of the second optical sheet;
step B of irradiating the molecular adhesive with light after the step A; and
step C of pressurizing and heating the flat portions and the third main surface in a state where the flat portions and the third main surface face each other:

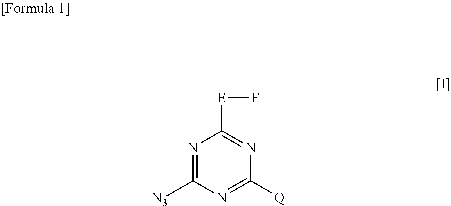

wherein E is any group; F is an OH group or an OH-generating group; −Q is —N₃ or —NR₁ (R₂); R₁ and R₂ in —NR₁ (R₂) are each H, a hydrocarbon group having 1 to 24 carbon atoms, or —RSi(R′)n(OA)3−n, where R is a chain hydrocarbon group having 1 to 12 carbon atoms, R′ is a chain hydrocarbon group having 1 to 4 carbon atoms, A is H or a chain hydrocarbon group having 1 to 4 carbon atoms, and n is an integer of 0 to 2; and R₁ and R₂ are the same as or different from each other.

### Item 15

The production method of Item 14, wherein in the step C, heating is performed to a temperature of 60° C. or higher and 150° C. or lower.

### Item 16

The production method of Item 14, wherein in the step C, heating is performed to a temperature of 80° C. or higher and 110° C. or lower.

### Advantageous Effects of Invention

According to embodiments of the present invention, there is provided an optical stack in which an optical sheet and another optical sheet are stacked without substantially affecting the shape and volume of dents on a surface with a concavo-convex structure of the optical sheet, as well as an optical device having such an optical stack. Also, according to embodiments of the present invention, there is provided a method for producing such an optical stack.

### BRIEF DESCRIPTION OF DRAWINGS

FIG. 1 is a schematic cross-sectional view of an optical stack 100 according to an embodiment of the present invention.

FIG. 2 is a schematic partial cross-sectional view of the optical stack 100.

FIG. 3 is a schematic partial cross-sectional view of an optical stack 200 of a comparative example.

FIG. 4A is a schematic plan view of a first optical sheet 10a of an optical stack according to an embodiment of the present invention.

FIG. 4B is a schematic cross-sectional view along line 4B-4B′ of the first optical sheet 10a shown in FIG. 4A.

### DESCRIPTION OF EMBODIMENTS

An optical stack according to an embodiment of the present invention and an optical device having such an optical stack, as well as a method for producing the optical stack, will be described. Embodiments of the present invention are not limited to what is illustrated below.

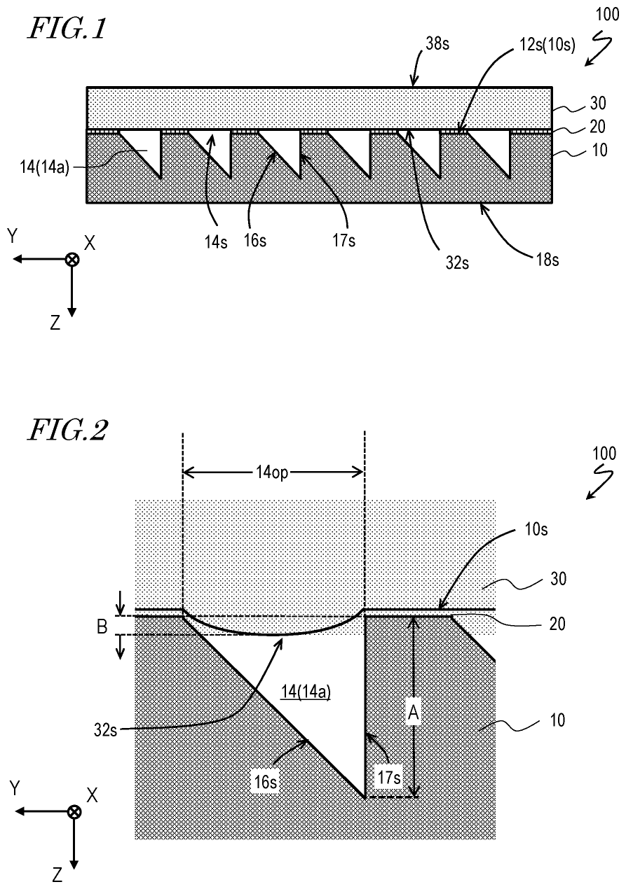

FIG. 1 shows a schematic cross-sectional view of an optical stack 100 according to an embodiment of the present invention. The optical stack 100 comprises: a first optical sheet 10 having a first main surface 12s with a concavo-convex structure and a second main surface 18s on the opposite side of the first main surface 12s; and a second optical sheet 30 having a third main surface 32s that is disposed on the side of the first main surface 12s of the first optical sheet 10. The second optical sheet 30 has a fourth main surface 38s on the opposite side of the third main surface 32s. The concavo-convex structure of the first main surface 12s includes: a plurality of dents 14; and flat portions 10s between adjacent dents 14 of the plurality of dents 14. The third main surface 32s is flat, and the flat portions 10s of the first main surface 12s and the third main surface 32s are bonded by covalent bonding via a molecular adhesive 20.

By each of the plurality of dents 14 of the first main surface 12s of the first optical sheet 10 and the third main surface 32s of the second optical sheet, a plurality of internal spaces 14a are defined. Typically, the internal spaces 14a are void portions filled with air inside. However, instead of air, the internal spaces 14a may be filled with a material having a lower refractive index than those of the first optical sheet 10 and the second optical sheet 30. The interfaces formed by the internal spaces 14a can cause total internal reflection (TIR) of light propagating in the optical stack 100.

Here, the flat portions 10s of the first main surface 12s and the second main surface 18s of the first optical sheet 10, and the third main surface 32s and the fourth main surface 38s of the second optical sheet 30 are parallel to the XY plane. For example, light propagating in the −Y direction in the second optical sheet 30 undergoes total internal reflection by the plurality of internal spaces 14a and is directed in the Z direction, which is perpendicular to the XY plane.

The first optical sheet 10 and the second optical sheet 30 are preferably formed of a light-transmitting resin. Here, resin is meant to broadly include elastomers and rubbers, in addition to thermoplastic resins and curable resins. Curable resins include, for example, thermosetting resins, photocurable resins, and electron beam-curable resins. Resins have, for example, a C—H bond or a Si—O bond. Examples of transparent thermoplastic resins include cellulose-based resins such as triacetyl cellulose (TAC), and polyester-based, polyvinyl alcohol-based, polycarbonate-based, polyamide-based, polyimide-based, polyethersulfone-based, polysulfone-based, polystyrene-based, polynorbornene-based, polyolefin-based, (meth)acrylic, acetate-based, and other transparent resins. Examples of thermosetting resins may include epoxy resins, phenolic resins, and polyester resins. Also, examples of photocurable resins include monomers (meant to include oligomers) having a vinyl group, an acrylate group (including a methacrylate group), an epoxy group, an isocyanate group, or an oxetane group. Specific examples of monomers include urethane acrylate-based, epoxy acrylate-based, ester acrylate-based, epoxy-based, and vinyl ether-based monomers.

The first optical sheet 10 and the second optical sheet 30 are selected in consideration of reactivity with the molecular adhesive 20. In other words, the materials of the first optical sheet 10 and the second optical sheet 30 are selected so that at least the flat portions 10s of the first main surface 12s and the third main surface 32s can form covalent bonding via the molecular adhesive 20. As necessary, at least the flat portions 10s of the first main surface 12s and/or the third main surface 32s may be subjected to surface modification (e.g., introduction of hydroxyl group by corona treatment). The flatness of the flat portions 10s of the first main surface 12s and the third main surface 32s, for example, preferably has a surface roughness Ra of 20 nm or less, more preferably 10 nm or less, and still more preferably 5 nm or less, as measured by an atomic force microscope. For example, the surface roughness Ra of the flat portions of the textured film used in Examples was about 3.9 nm, and the surface roughness Ra of the flat resin film was about 1.5 nm. Note that, although a resin film having a flat third main surface 32s is exemplified as the second optical sheet 30, it is sufficient that at least the portions of the third main surface 32s that face the flat portions 10s of the first main surface and form covalent bonding via the molecular adhesive 20 have the flatness described above.

The molecular adhesive 20 has a first reactive group RG1 that can form covalent bonding with the flat portions 10s of the first main surface 12s of the first optical sheet 10 and a second reactive group RG2 that can form covalent bonding with the third main surface 32s of the second optical sheet 30. The first reactive group RG1 and the second reactive group are different from each other. An individual molecule constituting the molecular adhesive 20 is sometimes referred to as an adhesive molecule 20. Also, regardless of the state before or after forming covalent bonding with the first optical sheet 10 and the second optical sheet 30, it is referred to as molecular adhesive 20 or adhesive molecule 20. However, the molecular adhesive 20 may contain components other than the adhesive molecule (e.g., polymerization initiator).

As described above, when the adhesive molecule 20 has the first reactive group RG1 that can form covalent bonding with the flat portions 10s of the first main surface 12s of the first optical sheet 10 and the second reactive group RG2 that can form covalent bonding with the third main surface 32s of the second optical sheet 30, the flat portions 10s of the first main surface 12s of the first optical sheet 10 and the third main surface 32 of the second optical sheet 30 are bonded by one adhesive molecule 20, the covalent bonding formed by the first reactive group RG1 of this adhesive molecule 20 and the flat portions 10s, and the covalent bonding formed by the second reactive group RG2 of this adhesive molecule 20 and the third main surface 32s.

In the case where the first reactive group RG1 or the second reactive group RG2 can react with itself to form covalent bonding (e.g., in the case where the second reactive groups RG2 can react with each other to form covalent bonding), a plurality of adhesive molecules 20 may intervene in the covalent bonding between the flat portions 10s of the first main surface 12s of the first optical sheet 10 and the third main surface 32s of the second optical sheet 30. For example, in the case where the adhesive molecule 20 has a plurality of silanol groups and/or alkoxysilyl groups, the adhesive molecule 20 may form covalent bonding by the reaction between the silanol groups and/or alkoxysilyl groups. At this time, for example, tens to hundreds of molecular layers of adhesive molecules 20 may intervene in the covalent bonding between the flat portions 10s of the first main surface 12s and the third main surface 32s of the second optical sheet 30. Of course, the minimum adhesive molecule 20 intervening in the covalent bonding between the flat portions 10s of the first main surface 12s and the third main surface 32s of the second optical sheet 30 may be a monomolecular layer (thickness of about 1 nm).

That is, the distance between the flat portions 10s of the first main surface 12s of the first optical sheet 10 and the third main surface of the second optical sheet 30 is about 1 nm or more, preferably about 500 nm or less, and more preferably about 100 nm or less. The molecular adhesive 20 contains a large number of such covalent bonding-forming adhesive molecules 20, but does not necessarily form a dense layer of adhesive molecules 20. When there are few reaction points to form covalent bonding at the flat portions 10s of the first main surface 12s and at the third main surface 32, the adhesive molecules 20 may be sparsely present.

Alternatively, the first reactive group RG1 of the adhesive molecule 20 may form covalent bonding with both the flat portions 10s of the first main surface 12s of the first optical sheet 10 and the third main surface 32s of the second optical sheet 30. At this time, an adhesive molecule (to be referred to as a first adhesive molecule) 20 that forms covalent bonding with the flat portions 10s of the first main surface 12s of the first optical sheet 10 by means of the first reactive group RG1 and an adhesive molecule (to be referred to as a second adhesive molecule) 20 that forms covalent bonding with the third main surface 32s of the second optical sheet 30 by means of the first reactive group RG1 bond the flat portions 10s of the first main surface 12s of the first optical sheet 10 and the third main surface 32s of the second optical sheet 30 by covalent bonding due to the formation of covalent bonding between the second reactive group RG2 of the first adhesive molecule and the second reactive group RG2 of the second adhesive molecule. At this time, there are two adhesive molecules 20 present between the flat portions 10s of the first main surface 12s of the first optical sheet 10 and the third main surface 32s of the second optical sheet 30. Also, as described above, in the case where the first reactive group RG1 or the second reactive group RG2 can react with itself to form covalent bonding, one or two or more third adhesive molecules, which are neither the first nor the second adhesive molecules, may intervene in the covalent bonding between the flat portions 10s of the first main surface 12s of the first optical sheet 10 and the third main surface 32s of the second optical sheet 30. Accordingly, the distance between the flat portions 10s of the first main surface 12s of the first optical sheet 10 and the third main surface 32s of the second optical sheet 30 is about 2 nm or more, preferably about 500 nm or less, and more preferably 100 nm or less.

The adhesive molecule 20 has at least one reactive group selected from the group consisting of an azide group, an amino group, a mercapto group, an isocyanate group, a ureido group, an epoxy group, a silanol group, and an alkoxysilyl group, for example. The alkoxysilyl group generates a silanol group by a hydrolysis reaction. The molecular adhesive 20 has, for example, an azide group as the first reactive group RG1 (or second reactive group RG2) and a silanol group or an alkoxysilyl group as the second reactive group RG2 (or first reactive group RG1). The adhesive molecule 20, for example, further has a triazine ring, and the azide group is bonded to the triazine ring. When the first reactive group RG1 is an azide group or an amino group and the second reactive group RG2 is a silanol group or an alkoxysilyl group, covalent bonding may be formed with the first reactive group to the surfaces of the first and second optical sheets and covalent bonding may be formed between the second reactive groups.

For example, the compounds (molecular adhesives, adhesive molecules) described in Japanese Patent No. 5083926, Japanese Patent No. 6452919, or Japanese Patent No. 6674594 can be suitably used. The entire disclosure of Japanese Patent No. 5083926, Japanese Patent No. 6452919, or Japanese Patent No. 6674594 is incorporated herein by reference.

The adhesive molecule 20 described in Japanese Patent No. 5083926 is represented, for example, by the following general formula [I]:

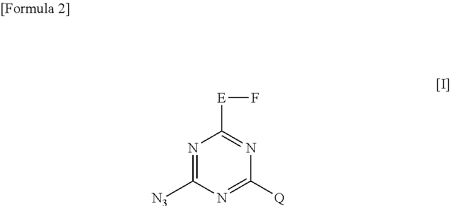

wherein E is any group; F is an OH group or an OH-generating group; −Q is —N₃ or —NR₁ (R₂); R₁ and R₂ in —NR₁ (R₂) are each H, a hydrocarbon group having 1 to 24 carbon atoms, or —RSi(R′)n(OA)3−n, where R is a chain hydrocarbon group having 1 to 12 carbon atoms, R′ is a chain hydrocarbon group having 1 to 4 carbon atoms, A is H or a chain hydrocarbon group having 1 to 4 carbon atoms, and n is an integer of 0 to 2; and R₁ and R₂ are the same as or different from each other.

Among the adhesive molecule 20 having a triazine ring represented by the above general formula [I], an adhesive molecule 20 having an azide group and a silanol group or an alkoxysilyl group is preferable. The azide group of this adhesive molecule 20 is bonded to the triazine ring.

The adhesive molecule has an alkoxysilyl group and an azide group. It further has a triazine ring. The azide group is preferably bonded directly to the triazine ring (C atom). The number of azide groups bonded to the triazine ring is, for example, one or two. The OH group or the OH-generating group (e.g., alkoxysilyl group) is preferably bonded indirectly to the triazine ring (C atom) via a spacer (e.g., amino group, oxy group, and/or hydrocarbon group). There are one or two or more alkoxysilyl groups indirectly bonded.

The azide group bonded to a triazine ring (electron-localized conjugated skeleton) has high decomposition energy to nitrene. Accordingly, effects due to near-ultraviolet ray and visible light are unlikely to occur. This improves the workability of ultraviolet exposure. Nitrene bonded to a triazine ring is stable compared to nitrene that is not. Bonding between nitrenes is suppressed. Hydrogen withdrawing activity for C—H bonds and addition activity for unsaturated bonds are enhanced. That is, an effective reaction is possible with a small amount of exposure.

The alkoxysilyl group is bonded to the triazine ring (electron-localized conjugated skeleton) via a spacer (e.g., amino group, oxy group, and/or hydrocarbon group). For this reason, in the case where the adhesive molecule is bonded to a surface of a resin, when in contact with the other surface of the resin, the entropy effect for generating a chemical bond is enhanced. The improvement of the entropy effect increases the frequency factor term in the interfacial reaction after the contact between the surfaces of the resins (the surface of the first optical sheet and the surface of the second optical sheet). As a result of this, the opportunity for the interfacial reaction is increased. The length of the spacer is reflected in the increase of the frequency factor in the interfacial reaction. When the length of the spacer is too long, the cost becomes high. In addition, a decrease in the amount of adhesive molecule adsorbed occurs. Accordingly, a spacer with a moderate length is preferable. From such a viewpoint, adhesive molecules represented by the following general formulas [Io], [Ia], and [Ib] are preferable.

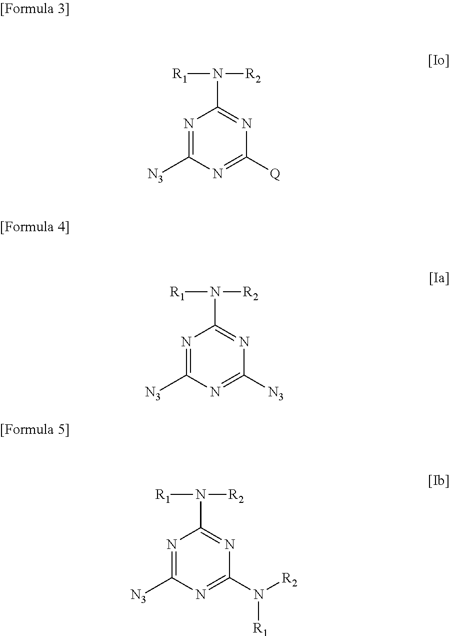

From the viewpoint of an increase in the frequency factor term in the interfacial reaction, the number of alkoxysilyl groups and azide groups present in one molecule is preferably large. However, from the viewpoint of cost and other factors, there are also restrictions on the number of such groups. That is, the adhesive molecules represented by the general formulas [Io], [Ia], and [Ib] are preferable.

The alkoxysilyl group in the general formulas [Io], [Ia], and [Ib] is in most cases an OH-generating group (OH precursor). In order to modify the OH-generating group to OH group, a treatment with water (neutral water, acidic water, alkaline water) is performed, for example. Besides, a corona discharge treatment and a plasma treatment are also considered. However, a water treatment is preferable.

An adhesion treatment (surface treatment: modification treatment) of an optical sheet (first optical sheet and/or second optical sheet) can be performed, for example, as follows.

At first, a treatment liquid (solution or dispersion) containing the adhesive molecule is prepared. Solvents used are water, alcohols (e.g., methanol, ethanol, isopropanol, ethylene glycol, propylene glycol, cellosolve, carbitol), ketones (e.g., acetone, methyl ethyl ketone, cyclohexanone), aromatic hydrocarbons (e.g., benzene, toluene, xylene), aliphatic hydrocarbons (e.g., hexane, octane, decane, dodecane, octadecane), esters (e.g., ethyl acetate, methyl propionate, methyl phthalate), ethers (e.g., tetrahydrofuran, ethyl butyl ether, anisole), and the like. Mixtures of different types of adhesive molecules may be used. The content of the adhesive molecule is 0.0001 to 10 mass %. It is particularly preferably 0.001 to 2 mass %. This is because it is not effective when the content of the adhesive molecule is too small. On the other hand, the amount of reaction with the optical sheets is limited, and thus too much is of little significance. From such a viewpoint, the above proportion is preferable.

In the treatment liquid, a surfactant is added as necessary from the viewpoint of adjustment of surface tension. For example, nonionic surfactants (e.g., nonionic surfactants composed of long alkyl chains and polyethylene glycol), cationic surfactants (e.g., quaternary ammonium salts), or anionic surfactants (e.g., organic carboxylates, sulfonates) are used.

An optical sheet is immersed in the treatment liquid. Alternatively, the treatment liquid is sprayed onto an optical sheet. By doing so, the adhesive molecule (molecular adhesive) is attached to the surface of the optical sheet.

After this, the optical sheet is irradiated with light (ultraviolet ray). In particular, only the locations where the adhesive molecule is desired to be bonded to the optical sheet are irradiated with light. In order to do this, a mask with an appropriate pattern is used. The irradiation with ultraviolet ray decomposes the azide group in the adhesive molecule. The decomposition of azide group generates nitrene. This nitrene attacks functional groups (e.g., —CH₃, —CH₂—, —CH<, —CH═CH—) on the surface of the optical sheet. Then, a hydrogen withdrawing radical addition or radical addition reaction occurs, resulting in a chemical bond between the adhesive molecule and the surface of the optical sheet. The chemical bond does not occur in unirradiated locations.

For the irradiation with ultraviolet ray, UV irradiation devices (e.g., high-pressure mercury UV lamps, low-pressure mercury UV lamps, fluorescent UV lamps (short ARC xenon lamps, chemical lamps), metal halide lamps) are used. Then, the optical sheet is irradiated with ultraviolet ray of 200 to 450 nm. When the amount of irradiation light is too little, it is difficult for the reaction to proceed. On the other hand, when the amount of irradiation light is too much, the optical sheet may be deteriorated. Accordingly, the preferred amount of irradiation light (light source wavelength: 254 nm) is 1 mJ/cm² to 5 J/cm². More preferably, it is 5 mJ/cm² to 1 J/cm².

In the case where the optical sheet has a complicated shape, the use of a reflector is effective in order to irradiate the optical sheet uniformly with UV light. Examples of reflectors include mirrors, surface-polished metal foils, Al mirror foils, SUS mirror foils, and silver-plated mirror plates. The shape, dimensions, materials and the like of the reflector are selected as appropriate from the viewpoint of reflection efficiency.

The optical stack 100 can be produced by the following production method, for example. The production method according to an embodiment of the present invention includes: step A of applying, for example, the adhesive molecule 20 represented by the above general formula [I] to at least one of the flat portions 10s of the first optical sheet 10 and the third main surface 32s of the second optical sheet 30; step B of irradiating the adhesive molecule 20 with light after the step A; and step C of pressurizing and heating the flat portions 10s and the third main surface 32s in a state where the flat portions 10s and the third main surface 32s face each other. In the step C, heating is performed to a temperature of, for example, 60° C. or higher and 150° C. or lower, more preferably 80° C. or higher and 110° C. or lower. The pressurization pressure is, for example, 0.01 MPa or more and 50 MPa or less, preferably 0.1 MPa or more and 5 MPa or less. The pressurization time is, for example, 0.1 minutes or longer and 200 minutes or shorter. The heating temperature and/or the heating time are set in consideration of the heat resistance of the first optical sheet 10 and the second optical sheet 30.

As the adhesive molecule, the adhesive molecule (molecular adhesive M) described in Japanese Patent No. 6674594 can also be used.

The adhesive molecule (molecular adhesive M) is an adhesive molecule having at least one reactive group (Zα) selected from the group consisting of an amino group (—NH₂), an azide group, a mercapto group, an isocyanate group, a ureido group, and an epoxy group, and at least one reactive group (Zβ) selected from the group consisting of a silanol group and a group that generates a silanol group by a hydrolysis reaction. Note that the reactive group (Zα) is preferably an amino group (—NH₂) or an azide group. Since an adhesive molecule containing an azide group is the same as the adhesive molecule described in Japanese Patent No. 5083926, the following describes an embodiment that mainly uses an adhesive molecule having an amino group.

The reactive group (Zα) in the adhesive molecule can form a chemical bond with a reactive substructure (Zγ) of a thermoplastic resin (P₁) in the optical sheet (first or second optical sheet). This chemical bond is thought to chemically fix the adhesive molecule to the surface of the optical sheet. The chemical bond is preferably covalent bonding. The thermoplastic resin (P₁) is, for example, at least one selected from the group consisting of olefin-based resins, cycloolefin-based resins, acrylic resins, olefin-vinyl acetate-based resins, olefin-based ionomer resins, and polyester resins.

The reactive group (Zβ) in the adhesive molecule forms a chemical bond with the surface of the other optical sheet (second or first optical sheet). The surface of the other optical sheet preferably has a hydroxyl group (hydroxy group) or a carboxy group (—COOH). By performing a surface treatment on the other optical sheet formed of a thermoplastic resin or a thermosetting resin, a hydroxyl group or a carboxyl group can be introduced. Examples of surface treatments include corona treatments, plasma treatments, ultraviolet ray irradiation treatments, electron beam irradiation treatments, ozone treatments, excimer ultraviolet ray treatments, acid treatments, and base treatments.

Examples of groups that generate a silanol group by a hydrolysis reaction include groups having a substructure represented by Si—X¹. Examples of X¹ include alkoxy groups having 1 to 10 carbon atoms such as a methoxy group, an ethoxy group, a n-propoxy group, and an isopropoxy group; halogen atoms such as a fluorine atom, a chlorine atom, and a bromine atom; and other hydrolyzable groups.

The thickness of the molecular adhesive applied to the optical sheets is preferably 200 nm or less, more preferably 150 nm or less, still more preferably 100 nm or less, and particularly preferably 50 nm or less. Also, the thickness of the molecular adhesive is preferably 0.5 nm or more, and more preferably 1 nm or more.

Meanwhile, the flat portions 10s of the first main surface 12s and the third main surface 32s have, for example, a hydrocarbon group (C—H group), a carbonyl group (—(C(═O)-group), a carboxyl group, and/or a hydroxyl group (OH group), forming covalent bonding with the adhesive molecule 20. For example, the azide group of the adhesive molecule 20 forms covalent bonding with the hydrocarbon group of the flat portions 10s of the first main surface 12s or the third main surface 32s after ultraviolet ray irradiation, the amino group forms covalent bonding with the carbonyl carbon, and the alkoxysilyl group forms covalent bonding with the hydroxyl group. The amino group forms covalent bonding with the hydroxyl group or carboxyl group.

For example, the molecular adhesive can be applied to the optical sheets as follows. For example, a molecular adhesive solution containing the molecular adhesive (M) is prepared, this solution is applied onto an optical sheet, and then a drying treatment for the resulting coating film or a treatment to fix the molecular adhesive to the optical sheet is performed.

The solvent used when preparing the molecular adhesive solution is not particularly limited. Examples of solvents include alcohol-based solvents such as methanol, ethanol, isopropanol, ethylene glycol, and diethylene glycol; ketone-based solvents such as acetone and methyl ethyl ketone; ester-based solvents such as ethyl acetate and butyl acetate; halogen-containing compound-based solvents such as methylene chloride; aliphatic hydrocarbon-based solvents such as butane and hexane; ether-based solvents such as tetrahydrofuran and butyl ether; aromatic compound-based solvents such as benzene and toluene; amide-based solvents such as N,N-dimethylformamide and N-methylpyrrolidone; and water. One of these may be used alone, or two or more thereof may be used in combination.

The concentration of the molecular adhesive (adhesive molecule) in the molecular adhesive solution is not particularly limited. That concentration is preferably 0.005 to 1.000 mol/L, and more preferably 0.050 to 0.500 mol/L. By setting the concentration of the adhesive molecule to 0.005 mol/L or more, the molecular adhesive can be efficiently applied onto the optical sheets. Also, by setting the concentration to 1.000 mol/L or less, unintended reactions in the molecular adhesive solution can be suppressed, resulting in excellent stability of the solution.

The application method of the molecular adhesive solution is not particularly limited, and known application methods can be used. Examples of application methods include a spin coating, a spray coating, a bar coating, a knife coating, a roll knife coating, a roll coating, a blade coating, a dip coating, a curtain coating, a die coating, and a gravure coating, but a bar coating and a gravure coating are preferable.

After applying the molecular adhesive solution, usually, a drying treatment is performed to dry the resulting coating film, either by natural drying or by putting into a drying mechanism. Among these, it is preferable to perform the drying treatment by putting into a drying mechanism from the viewpoint of improvement in productivity. Examples of drying mechanisms include batch-type drying mechanisms such as air ovens, and continuous drying mechanisms such as heat rolls and hot air through mechanisms (facilities in which the object to be dried is heated and dried while moving and passing through an open-type drying furnace and being exposed to a blast, etc.). Note that devices that can also be used as a part of these drying mechanisms, such as high frequency heating, heat medium circulation heaters such as oil heaters, and heaters such as far infrared heaters, can also be used as drying mechanisms themselves. Among these, hot air through mechanisms are preferable from the viewpoint of improvement in productivity. The drying temperature adjusted by the drying mechanism is usually 20 to 250° C., preferably 25 to 200° C., more preferably 30 to 150° C., and particularly preferably 35 to 120° C. The drying time is usually 1 second to 120 minutes, preferably 10 seconds to 10 minutes, more preferably 20 seconds to 5 minutes, and particularly preferably 30 seconds to 3 minutes.

Next, a treatment to fix the molecular adhesive to the optical sheet (hereinafter, sometimes referred to as fixation treatment) is performed. The fixation treatment can be selected as appropriate depending on the characteristics of the reactive group (Zα) of the molecular adhesive. Usually, application of the molecular adhesive onto the optical sheet generates a chemical bond and generation of the chemical bond is accelerated by heating, and therefore, it is preferable to perform a heating treatment from the viewpoint of improvement in productivity. The heating temperature is usually 40 to 250° C., preferably 60 to 200° C., and more preferably 80 to 120° C. The heating time is usually 1 second to 120 minutes, preferably 1 to 60 minutes, and more preferably 1 to 30 minutes. The heating method is not particularly limited, and the same mechanisms and devices as the drying mechanisms described above can be used.

The application of the molecular adhesive solution, the drying treatment, and the fixation treatment may be repeated multiple times.

In FIG. 1, for simplicity, the molecular adhesive 20 is shown only between the flat portions 10s of the first main surface 12s and the third main surface 32s, but it is not limited to this. For example, in the case where the first optical sheet 10 is immersed in a treatment liquid (solution or dispersion) containing the molecular adhesive 20, the molecular adhesive 20 can be attached to and remain over the entire first main surface 12s, i.e., not only on the flat portions 10s but also on first slopes 16s and second slopes 17s that constitute the dents 14. Also, in the case where the second optical sheet 30 is immersed in a treatment liquid containing the molecular adhesive 20, the molecular adhesive 20 can be attached to and remain over the entire third main surface 32s.

Note that even when the molecular adhesive 20 remains, it is at most a monomolecular layer of the adhesive molecule 20, which is smaller than the wavelength of visible light (400 nm or more and less than 760 nm) and has little effects on the optical characteristics. Also, the thickness (depth of the dents) of the first optical sheet 10 is several micrometers or more, and therefore, although the molecular adhesive 20 is shown in FIG. 1, the physical length (thickness) of the molecular adhesive 20 is negligibly small. Note that the treatment liquid containing the molecular adhesive 20 can be applied selectively only to the flat portions 10s by printing or other methods.

The molecular adhesive 20 present between the first optical sheet 10 and the second optical sheet 30 is at most a bimolecular layer thick, which is thinner than the wavelength of visible light and can thus be considered not optically present. Accordingly, when the refractive indices of the first optical sheet 10 and the second optical sheet 30 are matched, the first optical sheet 10 and the second optical sheet 30 can be bonded in a state where there is no interface in optical terms. The difference (absolute value) in refractive index between the first optical sheet 10 and the second optical sheet 30 is, for example, preferably 0.20 or less, more preferably 0.15 or less, and still more preferably 0.10 or less.

Next, referring to FIG. 2, the shape of the internal spaces 14a of the optical stack 100 will be described.

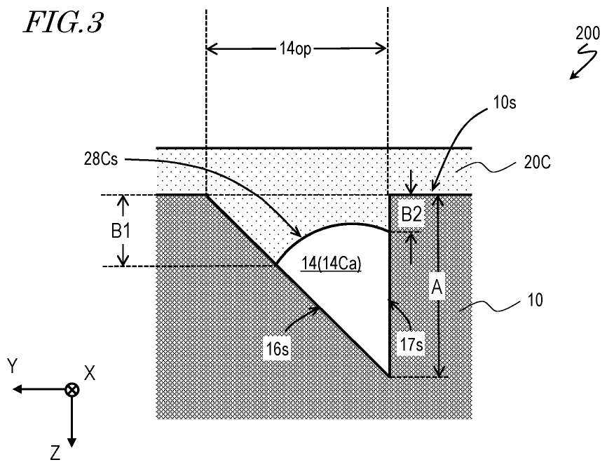

The optical stack 100 has the plurality of internal spaces 14a. The plurality of internal spaces 14a are defined by each of the plurality of dents 14 of the first main surface 12s of the first optical sheet 10 and the third main surface 32s of the second optical sheet. The molecular adhesive 20 is shown in FIG. 2 as well, but the physical length (thickness) of the molecular adhesive 20 is negligibly small. Accordingly, in the optical stack 100, the adhesive does not penetrate into the dents 14, as in an optical stack 200 that uses a conventional adhesive layer (adhesive layer 20C in FIG. 3).

However, the second optical sheet 30 may be deformed by the heating and pressurizing when the second optical sheet 30 adheres to the first optical sheet 10, causing the second optical sheet 30 to penetrate into the dents 14, as shown in FIG. 2. At this time, under the adhesion conditions, penetration of the second optical sheet 30 into the dents 14 can be suppressed if a second optical sheet 30 with sufficiently high stiffness is selected. Here, when the distance from an opening face defined by an opening 14op of the dent 14 (broken line in the opening 14op of the dent 14 in FIG. 2) to the deepest portion of the dent 14 is defined as A and the point at which the distance from the opening face to the third main surface 32 of the second optical sheet 30 that has penetrated into the dent 14 takes the maximum value B is defined as the point of maximum penetration, B/A can be 0.2 or less as illustrated in Examples later. B/A is preferably 0.15 or less, more preferably 0.10 or less, and still more preferably 0.05 or less.

Also, since penetration of the second optical sheet 30 into the dent 14 is due to flexure of the second optical sheet 30, the third main surface 32s is convex toward the bottom of the dent 14, as shown in the figure. Accordingly, when the point at which the distance from the opening face to the third main surface 32 of the second optical sheet 30 that has penetrated into the dent 14 takes the maximum value B is defined as the point of maximum penetration, the point of maximum penetration is positioned on the side of the deepest portion compared to a first slope 16s and a second slope 17s of the dent 14. In other words, even when the second optical sheet 30 penetrates into the dent 14, the second optical sheet 30 rarely comes into contact with the first slope 16s and/or the second slope 17s of the dent 14, and the area of the first slope 16s and/or the second slope 17s that form the interfaces that cause total internal reflection of the internal space 14a does not decrease.

As described above, according to embodiments of the present invention, the degree to which the second optical sheet 30 penetrates into the dents 14 can be sufficiently suppressed so that the shape of the internal spaces 14a can be substantially equal to the shape of the dents 14, and therefore, the optical characteristics (e.g., light distribution characteristics) can be obtained as designed.

For the type of the molecular adhesive and the adhesion conditions, it is preferable to select a second optical sheet 30 with stiffness that does not allow penetration into the dents 14. Also, even when the second optical sheet 30 does not penetrate into the dents 14, the dents 14 may be deformed if the heat resistance of the first optical sheet 10 is not sufficient. When the dents 14 are deformed, the desired optical characteristics cannot be obtained. Accordingly, for the type of the molecular adhesive and the adhesion conditions, it is preferable to select a first optical sheet 10 with stiffness (heat resistance) that does not deform the dents 14. In particular, the first optical sheet 10 is preferably formed of a cured material of a curable resin. Cured materials of curable resins have a cross-linked structure and are not thermally deformed easily. Accordingly, when heating and pressurizing are performed when the second optical sheet 30 adheres via the molecular adhesive, the dents 14 of the first optical sheet 10 can be prevented from being deformed. Note that a preliminary experiment may be conducted to predict the deformation upon adhesion and to form the dents 14.

FIG. 3 shows a schematic cross-sectional view of an optical stack 200 produced using an adhesive layer 20C. Note that, in FIG. 3, the second optical sheet 30 on the adhesive layer 20C is omitted. The thickness of the adhesive layer 20C is generally 1 μm or more, typically 4 μm or more, and is 10 or more times larger than the thickness of the molecular adhesive 20.

As shown in FIG. 3, when using the adhesive layer 20C, a surface 28Cs of the adhesive layer 20C on the side of the first optical sheet 10 penetrates into the dent 14. For example, if a common thermosetting adhesive is used, the adhesive is heated and pressurized during pasting, at which time the adhesive is softened, which allows the adhesive to penetrate into the dent 14. Also, in the case where a tackiness agent (pressure-sensitive adhesive) is used as well, the tackiness agent has low stiffness, and therefore, the tackiness agent penetrates into the dent 14 under the pressure during pasting.

The lower surface 28Cs of the adhesive layer 20C that has penetrated into the dent 14 is concave toward the bottom of the dent 14. This is due to the cohesion (surface tension) of the softened adhesive (or tackiness agent), in contrast to the third main surface 32s of the second optical sheet 30 shown in FIG. 2, which is convex toward the bottom of the dent 14. Accordingly, when the adhesive layer 20C is used for pasting, if the distance from the opening face defined by the opening 14op of the dent 14 to the deepest portion of the dent 14 is defined as A and the point at which the distance from the opening face to the lower surface 28Cs of the adhesive layer 20C that has penetrated into the dent 14 takes the maximum value B is defined as the point of maximum penetration, the point of maximum penetration is the point of contact with the first slope 16s or the second slope 17s of the dent 14, and the maximum value B of the distance to the lower surface 28Cs is either a distance B1 to the first slope 16s or a distance B2 to the second slope 17s in FIG. 3.

When using the adhesive layer 20C as described above, the distance to the lower surface 28Cs taking the maximum value B is the distance B1 to the first slope 16s or the distance B2 to the second slope 17s, and therefore, unlike the optical stack 100 of the embodiment described with reference to FIG. 2, the area of the first slope 16s and/or the second slope 17s that form the interfaces that cause the total internal reflection of the internal space 14Ca decreases.

In addition, although the degree of penetration into the dents 14 depends on the type of the adhesive and the conditions (temperature, pressure, time) during pasting, it is difficult to keep the degree of penetration low. The concave shape of the lower surface 28Cs of the adhesive layer 20C depends on the shape of the dent 14 and the way the pressure is applied (direction of stress acting on the adhesive) during pasting, but is generally asymmetric, and for example, as shown in FIG. 3, more penetration occurs at the smaller inclination angle (the angle to the flat portions 10s of the first main surface 12s of the first optical sheet 10). Accordingly, when the point at which the distance from the opening face to the lower surface 28Cs of the adhesive layer 20C that has penetrated into the dent 14 takes the maximum value B is defined as the point of maximum penetration, the point of maximum penetration is the point of contact with the first slope 16s of the dent 14 and the maximum value B is B1 in FIG. 3. Of course, B2 may be larger than B1 and B2 may be the maximum value B, or B1 may be equal to B2. In any case, it is difficult to keep B/A at 0.1 or less. FIG. 3 shows an example with B/A=about 0.4 (see Comparative Example 1 described later).

Accordingly, as shown in FIG. 3, the size and shape of the internal space 14Ca defined by the dent 14 and the adhesive layer 20C deviate significantly from the dent 14, and therefore, the optical characteristics (e.g., light distribution characteristics) deviate significantly from the design.

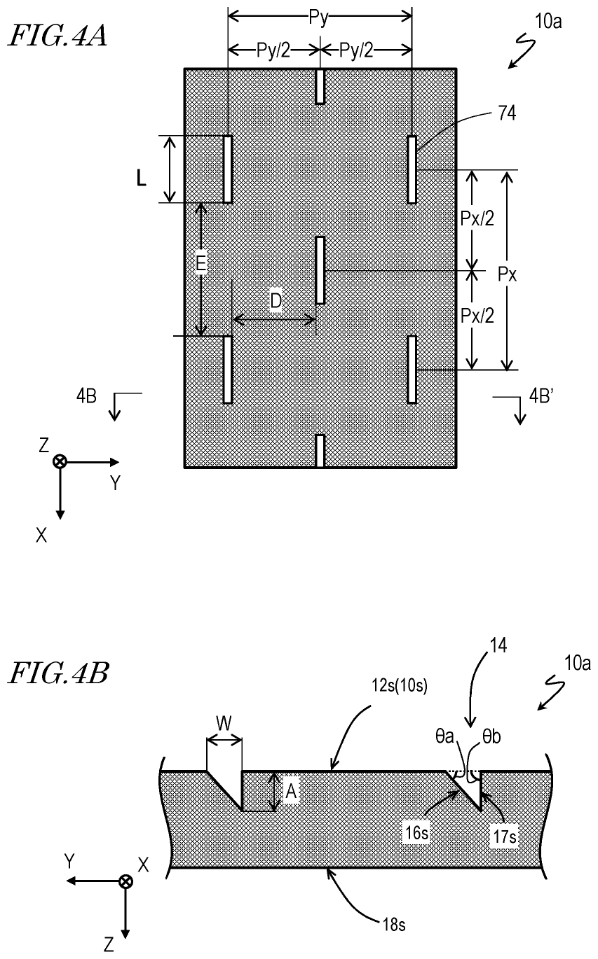

The first optical sheet 10 may be, for example, an optical sheet 10a shown in FIG. 4A and FIG. 4B. The optical sheet 10a with a concavo-convex structure (a plurality of dents 14) on its surface is sometimes referred to as textured film 10a. The optical stack 100 including the textured film 10a functions as the light distribution structure described in Patent Document 2 or Patent Document 3. For example, when a light source (e.g., LED device) is placed on a side surface of the second optical sheet 30 (e.g., left side in FIG. 1) and the second optical sheet 30 is utilized as a lightguide layer, light propagating in the −Y direction in the second optical sheet 30 undergoes total internal reflection by the plurality of internal spaces 14a and is directed in the Z direction, which is perpendicular to the XY plane. Note that another lightguide layer may be further provided on the side of the fourth main surface 38s of the second optical sheet 30, or the first optical sheet 10 or the optical stack 100 may be used as a lightguide layer. Light guide plates having the optical stack 100 can be in a variety of forms. As described above, light guide bodies having the optical stack 100 can be used in a variety of illumination devices.

As shown in FIG. 4A, when the textured film 10a is viewed from the normal direction of the first main surface 12s, the plurality of dents 14 are provided in island shapes that are discrete with respect to both the X direction and the Y direction. In the textured film 10a, the size (length L, width W: see FIG. 4A and FIG. 4B) of the dents 14 is such that the length L is preferably 10 μm or more and 500 μm or less, and the width W is preferably 1 μm or more and 100 μm or less, for example. Also, from the viewpoint of light extraction efficiency, the depth A is preferably 1 μm or more and 100 μm or less. The depth A of the dents 14 is preferably 20 μm or less, and more preferably 12 μm or less. The depth A of the dents 14 is preferably 4 μm or more, more preferably 6 μm or more, and more preferably 8 μm or more. In the case where the plurality of dents 14 are to be distributed discretely and uniformly, they may be disposed periodically as shown in FIG. 4A, for example. The pitch Px is, for example, 10 μm or more and 500 μm or less, and the pitch Py is, for example, 10 μm or more and 500 μm or less.

Regarding the density of the plurality of dents 14, when the textured film 10a is viewed from the normal direction of the main surface, a proportion (occupied area ratio) of the area of the plurality of dents 14 to the area of the textured film 10a is preferably 0.3% or more from the viewpoint of obtaining a good luminance. The occupied area ratio of the plurality of dents 14 is to be selected as appropriate in accordance with the intended application; for example, in applications where transparency is needed, it is preferably 30% or less in order to obtain a good visible light transmittance and haze value, and preferably 1% or more from the viewpoint of obtaining a good luminance. The upper limit value is still more preferably 25% or less, and, for a high visible light transmittance, it is preferably 10% or less, and still more preferably 5% or less. For example, it is preferably 0.3% or more and 10% or less, and more preferably 0.5% or more and 4% or less. In applications where a higher luminance is required, it is preferably 30% or more and 80% or less. Note that the occupied area ratio of the plurality of dents 14 may be uniform, or the occupied area ratio may increase with increasing distance from the light source to ensure that luminance will not decrease with increasing distance from the light source.

An inclination angle θa of the first slope 16s is, for example, 10° or more and 70° or less. The lower limit is preferably 30° or more, and more preferably 45° or more. When the inclination angle θa is smaller than 10°, the controllability of light distribution will decrease, and the light extraction efficiency may also decrease. On the other hand, when the inclination angle θa exceeds 70°, it may become difficult to process the textured film, for example. An inclination angle θb of the second slope 17s is, for example, 50° or more and 100° or less. The lower limit is preferably 70° or more. When the inclination angle θb is smaller than 50°, stray light may occur in unintended directions. On the other hand, when the inclination angle θb exceeds 100°, it may become difficult to process the textured film, for example. The inclination angle θa of the first slope 16s and the inclination angle θb of the second slope 17s are angles relative to a direction that is parallel to the Y direction, in a cross-section of the dent 14 (a cross-section that is perpendicular to the X direction and that is parallel to the YZ plane). In this example, the inclination angle θa of the first slope 16s is smaller than the inclination angle θb of the second slope 17s. In illumination devices having the optical stack 100, the first slope 16s is disposed closer to a light source than is the second slope 17s. The shape of a cross-section (a cross-section that is perpendicular to the X direction and that is parallel to the YZ plane) of the internal space 14a is defined by the inclination angle θa of the first slope 16s and the inclination angle θb of the second slope 17s, the width W, and the depth A. Without being limited to what is illustrated, the shape of the internal space 14a (dent 14) may be modified in various ways. By adjusting the shape, size, density of placement, etc., of the internal spaces 14a (dents 14), distribution of rays (intensity distribution) emitted from the optical stack 100 can be adjusted (see, for example, Patent Documents 2 and 3).

An example has been illustrated where the dents 14 have a triangular cross-sectional shape. Without being limited to this example, however, the cross-sectional shape of the dents 14 may be a rectangle (e.g., a trapezoid) so long as it has a surface that can form an interface for directing light in the Z direction via total internal reflection, for example. Without being limited to a polygon, it may be a shape including a curve.

The optical stack 100 may further have another optical sheet. In the case where the textured film 10a is formed using a curable resin, for example, the curable resin is applied onto a substrate layer (e.g., a transparent resin film such as PMMA film), a concavo-convex structure is formed on the curable resin layer, and by curing this, a textured film 10a formed of a cured material can be obtained. At this time, the textured film 10a is formed integrally on the substrate layer. In addition to this, the optical stack 100 may further have, for example, a lightguide layer, a light diffusion layer, an anti-reflection layer, a low-refractive index layer, a reflection layer, and a hard coat layer. The optical stack 100 may include an adhesive layer. The optical stack 100 can be produced by a roll-to-roll method, for example.

### EXAMPLES

Examples and Comparative Examples are illustrated below.

As the first optical sheet 10, a textured film 10a with a concavo-convex structure on its surface, described with reference to FIG. 4A and FIG. 4B, was produced according to the method described in Japanese National Phase PCT Laid-Open Publication No. 2013-524288. Specifically, the surface of a polymethyl methacrylate (PMMA) film was coated with a lacquer (manufactured by Sanyo Chemical Industries, Ltd., FINECURE RM-64: an acrylate-based photocurable resin); an optical pattern was embossed on the film surface including the lacquer; and thereafter the lacquer was cured (ultraviolet ray irradiation conditions: D bulb, 1000 mJ/cm², 320 mW/cm²) to produce the textured film 10a with the desired concavo-convex structure on the surface. The textured film 10a had a thickness of 20 μm. The total thickness including the textured film 10a and the PMMA film (substrate layer) was 60 μm, and the haze value was 3.2%. The textured film 10a and the PMMA film (substrate layer) are collectively referred to as a resin film A.

In this textured film 10a, a plurality of dents 14 having a length L of 80 μm, a width W of 17.3 μm, and a depth A of 10 μm and having a triangular cross-section are disposed at intervals with a width E (260 μm) along the X axis direction. Furthermore, patterns of such dents 14 are disposed at intervals with a width D (160 μm) along the Y axis direction. Px in FIG. 4A is 340 μm, and Py is 174 μm. The dents 14 had a density of 2426/cm² on the concavo-convex textured film surface. The inclination angle θa in FIG. 4B was about 60°, and the inclination angle θb was 85°. The occupied area ratio of the dents 14 was 3.4%.

As the second optical sheet 30, a polymethyl methacrylate (PMMA) film (thickness 30 μm) was used. This PMMA film is referred to as a resin film B.

As the molecular adhesive 20, a treatment liquid (solution) was used that was prepared by diluting 6-(3-triethoxysilylpropyl)amino-1,3,5-triazine-2,4-diazide (included in the general formula Ia) purchased from Sulfur Chemical Laboratory Inc. with ethanol to 0.5 mass %. Note that Sulfur Chemical Laboratory Inc. is the patentee of Japanese Patent No. 5083926.

An adhesive sheet for producing an optical stack of Comparative Example was produced as follows.

At first, an acrylic polymer was prepared. By using a four-necked flask equipped with stirring blades, a thermometer, a nitrogen gas inlet tube, and a condenser, 90.7 mass parts of n-butyl acrylate (BA), 6.3 mass parts of 4-acryloyl morpholine (ACMO), 2.7 mass parts of acrylic acid (AA), 0.3 mass parts of 4-hydroxybutyl acrylate (4HBA), and 0.1 mass parts of 2,2′-azobisisobutyronitrile as a polymerization initiator were placed in the flask together with ethyl acetate, so that the total of monomers was 50 mass %. After nitrogen replacement for 1 hour by introducing nitrogen gas with gentle stirring, the liquid temperature in the flask was kept at around 58° C. and the polymerization reaction was carried out for 8 hours, whereby an acrylic polymer was obtained. After 2 hours had elapsed from the start of the polymerization reaction, ethyl acetate was added dropwise over 3 hours to bring the solid content to 35 mass %. In other words, the acrylic polymer was obtained as an acrylic polymer solution with a solid content of 35 mass %.

Then, in the resultant acrylic polymer solution, 0.15 mass parts of a trimer adduct of trimethylolpropane/tolylene diisocyanate (manufactured by Tosoh Corporation; product name Coronate L) and 0.075 mass parts of dibenzoyl peroxide (manufactured by Nippon Oil & Fats Co., Ltd.: NYPER BMT40 (SV)) were added as cross-linking agents with respect to 100 mass parts of the polymer, thereby preparing an adhesive composition solution.

On one side of a polyethylene terephthalate (PET) film (product name: “MRF38”, manufactured by Mitsubishi Chemical Corporation) having a thickness of 38 μm and having been silicone release-treated, the adhesive composition solution was applied to form an adhesive composition solution layer. The application was performed so that the adhesive composition solution layer had a thickness after drying (i.e., thickness of the adhesive composition layer) of 5 μm. By drying the adhesive composition solution layer at 150° C. for 3 minutes, the solvent in the adhesive composition solution layer was removed, and the acrylic polymer was cross-linked by the cross-linking agent, whereby an adhesive composition layer was obtained. Next, the adhesive composition layer was pasted onto a release-treated surface of a polyethylene terephthalate (PET) film (product name: “MRE38”, manufactured by Mitsubishi Chemical Corporation) having a thickness of 38 μm and having been silicone release-treated, thereby producing an adhesive sheet having a layered structure of PET film/adhesive composition layer/PET film.

### Example 1

The resin film A and the resin film B were joined using the molecular adhesive described above.

The treatment liquid containing the molecular adhesive was applied to the surface with dents of the textured film 10a of the resin film A to a thickness of 16 μm. Thereafter, the surface was dried at 80° C. for 1 minute and irradiated with ultraviolet ray from the side to which the molecular adhesive was applied. Due to the ultraviolet ray irradiation, the azide group of the molecular adhesive is converted to nitrene, and nitrene reacts with a hydrocarbon (e.g., alkyl group) on the surface of the resin film A to form covalent bonding. For the ultraviolet ray irradiation, a LED lamp (manufactured by Quark Technology Co., Ltd., peak illuminance: 200 mW/cm²) was used, and irradiation with ultraviolet ray was performed to achieve an integrated light intensity of 100 mJ/cm² (wavelength: 245 nm). The illuminance of ultraviolet ray was measured using UV Power Puck (manufactured by Fusion UV Systems Japan K.K.). The thickness of the molecular adhesive was about 40 nm. The film thickness was measured by ellipsometry on the surface of the acrylic film coated with the molecular adhesive. Measurements were performed at incident angles of 60°, 70°, and 80° using a light source in a measurement wavelength range of 210 nm to 1690 nm.

For the resin film B as well, in the same manner as for the resin film A, the molecular adhesive was applied to the surface of the resin film B to a thickness of about 40 nm, and allowed to react.

In a state where the respective surfaces of the resin film A and the resin film B to which the molecular adhesive were bonded faced each other, heating and pressurizing were performed for 5 minutes at 100° C. and 0.5 MPa using a precision press machine. By this heating and pressurizing, silanol groups generated by hydrolysis of the alkoxysilyl groups of the molecular adhesive undergo a coupling reaction to form covalent bonding.

### Example 2

An optical stack was produced in the same manner as in Example 1 except that the temperature during heating and pressurizing was changed to 110° C.

### Comparative Example 1

One of the PET films having been release-treated was peeled off from the above adhesive sheet, and the exposed adhesive composition layer was pasted onto the resin film B (thickness: 20 μm), and then the other separator (PET film) was peeled off and the adhesive composition layer was pasted onto the concavo-convex surface of the textured film 10a of the resin film A under a pressure of 0.05 MPa, thereby obtaining an optical stack having a layered structure of resin film B/adhesive composition layer/resin film A.

The optical stacks obtained were evaluated as follows. The results are shown in Table 1.

TABLE 1

| | | Depth A | Maximum | | | Haze | Heating | Pressurization | |
|---|---|---|---|---|---|---|---|---|---|
| | Adhesion | of dents | penetration | | Bending | value | temperature | pressure | Time |
| | mechanism | (μm) | value B (μm) | B/A | adhesiveness | (%) | (° C.) | (MPa) | (min) |
| Example 1 | Molecular | 7.3 | 0.0 | 0.00 | ◯ | 3.9 | 100 | 0.5 | 5 |
| | adhesive | | | | | | | | |
| Example 2 | Molecular | 7.3 | 0.8 | 0.11 | ◯ | 3.8 | 110 | 0.5 | 5 |
| | adhesive | | | | | | | | |
| Comparative | Adhesive | 7.4 | 2.7 | 0.36 | ◯ | 3.3 | — | — | — |
| Example 1 | | | | | | | | | |

### <Shape of Internal Space>

The depth A and the maximum penetration value B of the dents 14 were determined from a cross-sectional SEM image of the optical stack. For each optical stack, A and B were determined from cross-sectional images of multiple arbitrarily selected locations, and their averages were shown in Table 1.

The shape of the internal spaces in the optical stack of Example 1 was similar to the internal spaces 14a shown in FIG. 1, with the second optical sheet 30 not penetrating into the dents 14 and maintaining the shape of the dents 14 as is. Meanwhile, the shape of the internal spaces in the optical stack of Example 2, which was pressurized at a higher temperature than the optical stack of Example 1, had the same shape as the internal space 14a shown in FIG. 2, with the second optical sheet 30 slightly penetrating into the dent 14. B/A was about 0.1, which was a sufficiently small value of 0.2 or less. The internal spaces in the optical stack of Comparative Example 1 had the same shape as the internal space 14Ca shown in FIG. 3. The maximum penetration value B was B1, and B/A was about 0.4, which was a large value.

### <Bending Adhesiveness>

For curved surface followability, the optical stacks were pasted onto a curved surface (30 mm wide×80 mm long) of a cylindrical test piece of polymethyl methacrylate with an outer diameter of 90 mm, left for 5 days at room temperature, and evaluated for lifting and peeling. Also, lifting and peeling were evaluated after leaving the optical stacks in an environment of 23° C. and 65% RH for 7 days and after leaving the optical stacks in an environment of 85° C. and 85% RH for 1,000 hours. It was found that all of the optical stacks of Examples 1 and 2 and Comparative Example 1 had sufficient bending adhesiveness.

### <Haze Value>

The haze value of each optical stack was measured by using a haze meter (machine name: “HZ-1”, manufactured by Suga Testing Machinery Co.) with D65 light. The haze value of all of the optical stacks exhibited only a slight increase from the haze value of 3.2% of the above textured film.

### INDUSTRIAL APPLICABILITY

Optical stacks according to embodiments of the present invention can be broadly used in optical devices, such as display devices or illumination devices.

### REFERENCE SIGNS LIST

10, 10a first optical sheet
12s first main surface
18s second main surface
molecular adhesive (adhesive molecule)
second optical sheet
32s third main surface
38s fourth main surface
100, 200 optical stack

1. An optical stack comprising:
a first optical sheet having a first main surface with a concavo-convex structure and a second main surface on an opposite side from the first main surface; and
a second optical sheet having a third main surface that is disposed on a side of the first main surface of the first optical sheet, wherein,
the concavo-convex structure of the first main surface includes a plurality of dents and flat portions between two dents that are adjacent to each other of the plurality of dents, and
the flat portions of the first main surface and the third main surface are bonded by covalent bonding via a molecular adhesive.

2. The optical stack of claim 1, wherein for each of the plurality of dents, when a distance from an opening face defined by an opening of the dent to a deepest portion of the dent is defined as A and a point at which a distance from the opening face to the third main surface of the second optical sheet that has penetrated into the dent takes a maximum value B is defined as a point of maximum penetration, B/A is 0.2 or less.

3. The optical stack of claim 2, wherein the point of maximum penetration is positioned on a side of the deepest portion compared to a side surface of the dent.

4. The optical stack of claim 1, wherein a distance between the flat portions and the third main surface does not exceed 500 nm.

5. An optical stack comprising:
a first optical sheet having a first main surface with a concavo-convex structure and a second main surface on an opposite side from the first main surface; and
a second optical sheet having a third main surface that is disposed on a side of the first main surface of the first optical sheet, wherein,
the concavo-convex structure of the first main surface includes a plurality of dents and flat portions between two dents that are adjacent to each other of the plurality of dents,
for each of the plurality of dents, when a distance from an opening face defined by an opening of the dent to a deepest portion of the dent is defined as A and a point at which a distance from the opening face to the third main surface of the second optical sheet that has penetrated into the dent takes a maximum value B is defined as a point of maximum penetration, B/A is 0.2 or less, and
a distance between the flat portions and the third main surface does not exceed 500 nm.

6. The optical stack of claim 5, wherein the flat portions of the first main surface and the third main surface are bonded by covalent bonding via a molecular adhesive.

7. The optical stack of claim 1, wherein the molecular adhesive has at least one reactive group selected from the group consisting of an azide group, an amino group, a mercapto group, an isocyanate group, a ureido group, an epoxy group, a silanol group, and an alkoxysilyl group.

8. The optical stack of claim 1, wherein the molecular adhesive has an azide group, and a silanol group or an alkoxysilyl group.

9. The optical stack of claim 8, wherein the molecular adhesive further has a triazine ring, and the azide group is bonded to the triazine ring.

10. The optical stack of claim 9, wherein the flat portions and the third main surface have at least one reactive group selected from the group consisting of a hydrocarbon group, a carbonyl group, and a hydroxyl group, and form covalent bonding with the molecular adhesive.

11. The optical stack of claim 1, wherein the first optical sheet is formed of a cured material of a curable resin.

12. The optical stack of claim 1, having a haze value of 5.0% or less.

13. An optical device comprising a light guide plate having the optical stack of claim 1.

14. A method for producing the optical stack of claim 1, the method comprising:
applying a molecular adhesive represented by the following general formula [I] to at least one of the flat portions of the first optical sheet and the third main surface of the second optical sheet;
irradiating the molecular adhesive with light after the applying; and
pressurizing and heating the flat portions and the third main surface in a state where the flat portions and the third main surface face each other: 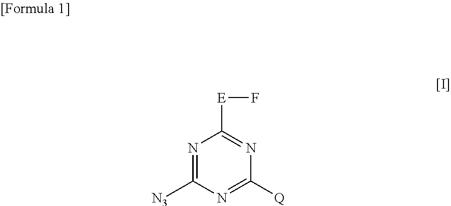
wherein E is any group; F is an OH group or an OH-generating group; −Q is —N₃ or —NR₁(R₂); R₁ and R₂ in —NR₁(R₂) are each H, a hydrocarbon group having 1 to 24 carbon atoms, or —RSi(R′)n(OA)3−n, where R is a chain hydrocarbon group having 1 to 12 carbon atoms, R′ is a chain hydrocarbon group having 1 to 4 carbon atoms, A is H or a chain hydrocarbon group having 1 to 4 carbon atoms, and n is an integer of 0 to 2; and R₁ and R₂ are the same as or different from each other.

15. The production method of claim 14, wherein in the pressurizing and heating, heating is performed to a temperature of 60° C. or higher and 150° C. or lower.

16. The production method of claim 14, wherein in the pressurizing and heating, heating is performed to a temperature of 80° C. or higher and 110° C. or lower.
